(19) United States
(12) Patent Application Publication
(10) Pub. No.: US 2024/0120838 A1
(43) Pub. Date: Apr. 11, 2024

(54) DC-DC CONVERTER CIRCUIT AND CORRESPONDING METHOD OF OPERATION

(71) Applicant: STMicroelectronics S.r.l., Agrate Brianza (MB) (IT)

(72) Inventors: Alessandro BERTOLINI, Vermiglio (IT); Alberto CATTANI, Cislago (IT); Alessandro GASPARINI, Cusano Milanino (IT)

(73) Assignee: STMicroelectronics S.r.l., Agrate Brianza (MB) (IT)

(21) Appl. No.: 18/376,328

(22) Filed: Oct. 3, 2023

(30) Foreign Application Priority Data
Oct. 6, 2022 (IT) 102022000020592

(51) Int. Cl. H02M 3/158; H02M 1/00

(52) U.S. Cl. CPC H02M 3/158; H02M 1/0035

(57) ABSTRACT

In a DC-DC converter, a duty-cycle control signal is generated in response to comparing the switching stage output voltage and a reference voltage signal. A first circuit compares the duty-cycle control signal and a ramp to produce a PWM signal. A second circuit compares the duty-cycle control signal and a skip threshold to produce a skip control signal which halts switching operation of the switching stage. A count is made of number of periods of the skip control signal during a monitoring time window and the number of periods of a clock signal during a period of the skip control signal is counted. When the counted number of skip control signal periods is within a first range and the counted number of clock signal periods is within a second range, a common detection signal is asserted to trigger varying a value of the skip threshold signal.

### PRIORITY CLAIM

This application claims the priority benefit of Italian Application for Patent No. 102022000020592 filed on Oct. 6, 2022, the content of which is hereby incorporated by reference in its entirety to the maximum extent allowable by law.

### TECHNICAL FIELD

The description relates to DC-DC switching converters, in particular to DC-DC converters configured to operate in discontinuous conduction mode (DCM) or pulse-skip mode at light load conditions.

### BACKGROUND

DC-DC converters are used in various applications to generate the supply voltage rails required by complex systems to operate correctly and according to the expected performance. Many of such systems are designed for high efficiency and high performance, and often the converter is “tailored” in the design phase to satisfy the application scenarios of the customer. In order to improve both efficiency and performance, conventional DC-DC converters may operate in a plurality of operation modes. In particular, at heavy load conditions, the converter is expected to operate in continuous conduction mode (CCM), i.e., relying on pulse-width modulated (PWM) control at a certain (fixed) switching frequency F_{SW}. At light load conditions, the converter is instead expected to operate in discontinuous conduction mode (DCM) or pulse-skip mode to reduce energy consumption. Pulse-skip mode operation is used to reduce the switching activity in a controlled way, and it leads to increased efficiency at low load (e.g., a reduction of the converter quiescent current).

The need for plural operating modes in a DC-DC converter may be better understood with reference to FIGS. 1A and 1B. In particular, FIG. 1A shows diagrams exemplary of the power losses Pₗₒₛₛ (upper portion) and the efficiency η (lower portion) of a DC-DC converter as a function of the load current I_{LOAD}, where the converter operates in PWM mode over the entire range of I_{LOAD}. FIG. 1B shows diagrams exemplary of the power losses Pₗₒₛₛ (upper portion) and the efficiency η (lower portion) of a DC-DC converter as a function of the load current I_{LOAD}, where the converter operates in skip mode at light load (i.e., when the load current I_{LOAD} is lower than a threshold I_{TH}: I_{LOAD}<I_{TH} and in PWM mode at heavy load (i.e., when the load current I_{LOAD} is higher than threshold I_{TH}: I_{LOAD}>I_{TH}). In the upper diagrams of FIGS. 1A and 1B, various contributions to the power loss Pₗₒₛₛ are indicated, in particular: a quiescent contribution (solid line), a switching contribution (dotted line), and a conduction contribution (dash-and-dot line). Loss mechanisms in a PWM-operated DC-DC converter can thus be broadly classified into three categories: conduction losses, switching losses, and static losses due to quiescent current drawn by the control and other auxiliary circuitry. In PWM mode, the converter regulates the output by operating at a fixed frequency F_{SW}, therefore switching losses and static losses are constant, whereas conduction losses scale as a function of (e.g., proportionally to) the load current. Large switching losses that come with high switching frequencies severely degrade efficiency at light load conditions.

Consequently, as indicated in FIG. 1B, efficiency at light load can be improved resorting to the following techniques: the converter is no longer operated in CCM, but in DCM, so that the coil current is not allowed to turn negative and the load is prevented from discharging towards the input supply; and/or the switching activity is reduced while maintaining output regulation; in this case, a higher output ripple has to be tolerated.

In the art and in the present description, the term skip-mode is generally used to indicate a non-PWM operation, in which the output regulation of the converter is obtained by changing the switching frequency rather than modulating the duty-cycle of the converter control signal. A particular case of skip-mode is the pulse-frequency modulation (PFM), also referred to as “single-pulse operation”, in which the converter switching frequency is modulated according to the need of the output load (i.e., the lower the load, the lower the switching activity). Another skip-mode is the burst-mode: in this case, skip operation is obtained by deliberately avoiding (skipping) one or more PWM cycles, so that the converter operates in a sort of hybrid mode between PFM and PWM. In contrast to PFM, in burst-mode the converter does not operate in single pulse, since it provides multiple pulses or packets of charge (i.e., a train or burst of pulses) to the output and then waits again. The term skip-mode is generally used to indicate also the burst-mode.

All the aforementioned skip-modes are known in the art (usually simply indicated as low-power modes) and are effective in reducing the quiescent consumptions at light load and thus increase efficiency.

In a particular field of application, such as DC-DC converters for supplying AMOLED displays (e.g., for smart phones, tablets, smart watches and the like), a desired feature is the possibility to selectively avoid operation of the converter in specific frequency bands, both in terms of converter switching frequency and skip/burst activity averaged on a sampling window. Such (programmable) “stop bands” typically span in the range between 1 kHz and 100 kHz and may be changed on-the-fly by the customer. For instance, a first stop band may span the range of 15 kHz to 35 kHz, a second stop band may span the range of 30 kHz to 50 kHz, and a third stop band may span the range of 60 kHz to 80 kHz, and the DC-DC converter may be programmable to switch from one stop band to another on the fly. In this context, the DC-DC converter is requested to have the capability to monitor its activity and detect when its operation lays within such undesired frequency bands. The converter is thus configured to change its operation when it detects that it is operating in steady state inside a forbidden frequency band.

Typically, avoiding the stop band(s) is not an issue when the converter operates in CCM, since the switching frequency F_{SW} is usually well above the upper limit of the stop band(s) (e.g., F_{SW} may be around 1.5 MHz). Avoiding operation in the stop band(s) when the converter operates in a skip/burst operation mode (e.g., in the light load operation region) may instead be more difficult.

When the DC-DC converter is operating in a skip mode within a forbidden frequency band, its operation has to be changed without compromising performance. In particular, the converter should remain in a skip mode without moving into a fixed frequency DCM/CCM mode (i.e., without moving to pure PWM-operation) in order to not degrade light-load efficiency and/or quiescent consumption. Also, the output ripple should still not exceed the maximum specified limit, and performance in the CCM mode (e.g., stability, efficiency, current capability, etc.) should not be affected.

Additionally, capability of the converter to avoid operating in certain prohibited frequency bands while still meeting the expected performance should be preserved in respect of possible variations, e.g., due to: operating conditions and parameters (e.g., variations of the input voltage V_{IN}, the output voltage V_{OUT}, the load, the inductance L, the capacitance C, the switching frequency F_{SW}, parasitic effects, etc.); process, voltage or temperature (PVT) variations; and/or other causes taking place also after final test, packaging and assembly of the converter circuit (e.g., aging, soldering, etc.).

Therefore, there is a need in the art to provide DC-DC converters with improved operation (e.g., improved control algorithms) in respect of the stop band avoidance function, particularly at light load conditions.

There is a need in the art to contribute in providing such improved DC-DC converters.

### SUMMARY

One or more embodiments may relate to a DC-DC converter circuit.

One or more embodiments may relate to a corresponding method of operating a DC-DC converter.

According to a first aspect of the present description, a switching stage in a DC-DC converter circuit is configured to produce an output voltage. An error amplifier has a first input terminal configured to receive a feedback signal indicative of the output voltage and a second input terminal configured to receive a reference voltage signal to produce a duty-cycle control signal for the DC-DC converter. A first comparator has a first input terminal configured to receive the duty-cycle control signal and a second input terminal configured to receive a ramp signal to produce a pulse-width modulated drive signal for controlling the switching stage. A second comparator has a first input terminal configured to receive the duty-cycle control signal and a second input terminal configured to receive a skip threshold signal to produce a skip control signal for controlling the switching stage. The switching operation of the switching stage is halted in response to the skip control signal being de-asserted. A clock generator is configured to produce a clock signal. A control circuit is configured to: count the number of periods of the skip control signal during a monitoring time window having a defined duration; count the number of periods of the clock signal during a period of the skip control signal; assert a common detection signal when the counted number of periods of the skip control signal is within a first range and the counted number of periods of the clock signal is within a second range; and vary a value of the skip threshold signal in response to the common detection signal being asserted.

One or more embodiments may thus facilitate avoiding operation of the DC-DC converter in a forbidden frequency band, particularly at light load conditions when the converter operates in skip-mode.

In one or more embodiments, the control circuit includes a first counter configured to receive the clock signal at a respective clock input terminal and a first enable signal at a respective asynchronous reset terminal. The first counter is reset in response to the first enable signal being de-asserted, and counts the pulses of the clock signal in response to the first enable signal being asserted to produce a first count value. The control circuit includes a first logic circuit configured to receive the clock signal, the skip control signal and the first count value and produce the first enable signal and a first detection signal. The first enable signal is asserted when an edge of the clock signal is detected and is de-asserted when the first count value is higher than an upper limit of the second range, and is further periodically de-asserted at the start of each period of the skip control signal. The first detection signal is asserted when an edge of the skip control signal is detected, and is de-asserted when the first count value is higher than the upper limit of the second range or if, at the start of a period of the skip control signal, the first count value is outside of the second range.

In one or more embodiments, the control circuit includes a second counter configured to receive the clock signal at a respective clock input terminal and a second enable signal at a respective asynchronous reset terminal. The second counter is reset in response to the second enable signal being de-asserted, and counts the pulses of the clock signal in response to the second enable signal being asserted to produce a timer count value. The control circuit includes a third counter configured to receive the skip control signal at a respective clock input terminal and the second enable signal at a respective asynchronous reset terminal. The third counter is reset in response to the second enable signal being de-asserted, and counts the pulses of the skip control signal in response to the second enable signal being asserted to produce a second count value. The control circuit includes a second logic circuit configured to receive the clock signal, the skip control signal, the first count value, the first detection signal, the second count value and the timer count value and produce the second enable signal and the common detection signal. The second enable signal is asserted in response to a pulse in the clock signal and is de-asserted in response to: i) the clock signal being de-asserted and the second count value being equal to 0 and the skip control signal being de-asserted, or ii) the timer count value reaching a threshold value, or iii) the second count value being higher than the first range, or iv) the first detection signal being de-asserted. The common detection signal is asserted if, when the timer count value reaches a threshold value, the second count value is within the first range.

In one or more embodiments, the DC-DC converter circuit includes a fourth counter configured to produce a third count value indicative of the number of consecutive assertions of the common detection signal. The control circuit is configured to vary the value of the skip threshold signal as a function of the third count value.

In one or more embodiments, the control circuit is configured to iteratively adjust the value of the skip threshold signal in response to the third count value increasing, in particular iteratively increasing the value of the skip threshold signal while the third count value is lower than a threshold value and iteratively decreasing the value of the skip threshold signal while the third count value is higher than a threshold value.

In one or more embodiments, a resistive voltage divider is configured to produce a plurality of voltage signals, and a multiplexer circuit is configured to select, as a function of the third count value, one voltage signal in the plurality of voltage signals and pass the selected voltage signal to the second input terminal of the second comparator.

In one or more embodiments, a reference input node is configured to receive a further reference voltage signal, and a voltage buffer circuit is configured to propagate the further reference voltage signal to a first terminal of a resistor. The resistor has a second terminal coupled to the second input terminal of the second comparator. A programmable current source is configured to source a programmable current to the second terminal of the resistor. The value of the programmable current is dependent on the third count value.

In one or more embodiments, a reference input node is configured to receive a further reference voltage signal. A voltage buffer circuit is configured to propagate the further reference voltage signal to a first terminal of a programmable resistor. The programmable resistor has a second terminal coupled to the second input terminal of the second comparator. The resistance value of the programmable resistor is dependent on the third count value. A current source is configured to source a current to the second terminal of the programmable resistor.

According to another aspect of the present description, a method of operating a DC-DC converter circuit according to one or more embodiments includes: producing, at the switching stage, an output voltage; receiving, at the error amplifier, a feedback signal indicative of the output voltage and a reference voltage signal, thereby producing a duty-cycle control signal for the DC-DC converter; receiving, at the first comparator, the duty-cycle control signal and a ramp signal, thereby producing a pulse-width modulated drive signal for controlling the switching stage; receiving, at the second comparator, the duty-cycle control signal and a skip threshold signal, thereby producing a skip control signal for controlling the switching stage, wherein the switching operation of the switching stage is halted in response to the skip control signal being de-asserted; producing, at the clock generator, a clock signal; counting the number of periods of the skip control signal during a monitoring time window having a defined duration; counting the number of periods of the clock signal during a period of the skip control signal; asserting a common detection signal when the counted number of periods of the skip control signal is within a first range and the counted number of periods of the clock signal is within a second range; and varying a value of the skip threshold signal in response to the common detection signal being asserted.

### BRIEF DESCRIPTION OF THE DRAWINGS

One or more embodiments will now be described, by way of example only, with reference to the annexed figures, wherein:

FIGS. 1A and 1B, previously presented, are diagrams exemplary of the power losses and efficiency of a DC-DC converter as a function of the output (load) current;

FIG. 2 is a circuit diagram exemplary of components of a control loop of a DC-DC converter including a pulse-skip function;

FIG. 3A is a circuit block diagram exemplary of a first portion of a control circuit of a DC-DC converter according to one or more embodiments of the present description;

FIG. 3B is a state diagram exemplary of operation states of a finite state machine of the control circuit of FIG. 3A;

FIG. 4A is a circuit block diagram exemplary of a second portion of a control circuit of a DC-DC converter according to one or more embodiments of the present description;

FIG. 4B is a state diagram exemplary of operation states of a finite state machine of the control circuit of FIG. 4A;

FIG. 5 is a circuit block diagram exemplary of a third portion of a control circuit of a DC-DC converter according to one or more embodiments of the present description;

FIGS. 6 and 7 are circuit diagrams exemplary of a control loop of a DC-DC converter including a pulse-skip function according to embodiments of the present description; and

FIG. 8 is a time diagram exemplary of the possible time evolution of signals in one or more embodiments of the present description.

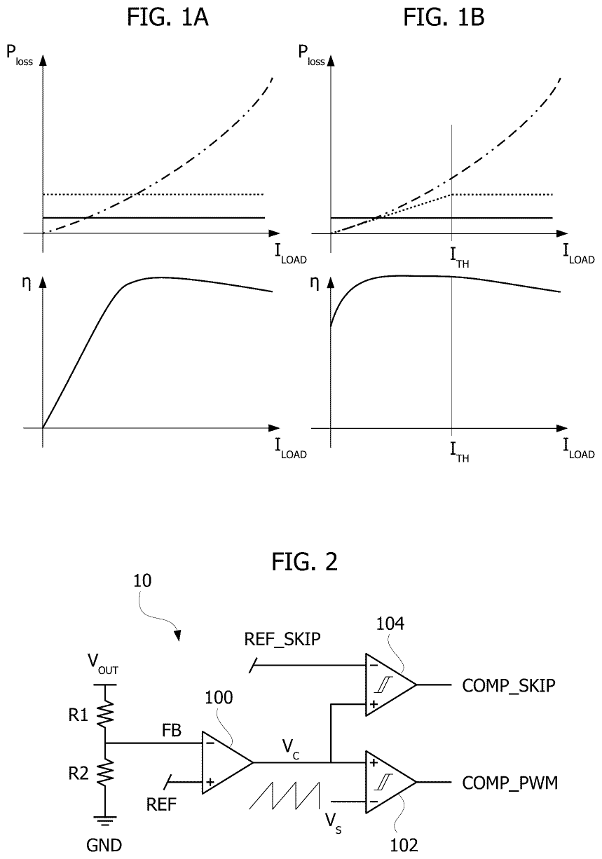

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures, unless the context indicates otherwise, like parts or elements are indicated with like references/numerals and a corresponding description will not be repeated for the sake of brevity.

By way of introduction to the detailed description of exemplary embodiments, reference may first be made to FIG. 2, which is a circuit diagram exemplary of components of a control loop 10 of a DC-DC converter including a pulse-skip function. The control loop 10 includes a voltage divider configured to receive the converter output voltage V_{OUT} and produce a feedback voltage signal FB indicative of (e.g., proportional to) the output voltage V_{OUT}. For instance, the voltage divider may include a first resistor R1 and a second resistor R2 coupled in series between the output node of the converter and a reference (e.g., ground) node GND (e.g., at 0 V), and the feedback signal FB may be produced at a node intermediate resistors R1 and R2. The control loop includes an error amplifier 100 having a first (e.g., inverting) input node configured to receive the feedback signal FB and a second (e.g., non-inverting) input node configured to receive a reference voltage signal REF. The error amplifier 100 may thus produce an output control signal V_{C} as a function of (e.g., amplifying) the difference between signals REF and FB. The control loop includes a first comparator 102 (e.g., with hysteresis) having a first (e.g., non-inverting) input node configured to receive the control signal V_{C} and a second (e.g., inverting) input node configured to receive a ramp signal V_{S}. The comparator 102 may thus produce an output pulse-width modulated (PWM) signal COMP_PWM that is used to drive the switching stage of the DC-DC converter (not visible in the Figures). The control loop includes a second comparator 104 (e.g., with hysteresis) having a first (e.g., non-inverting) input node configured to receive the control signal V_{C} and a second (e.g., inverting) input node configured to receive a further reference voltage signal REF_SKIP. The comparator 104 may thus produce an output skip control signal COMP_SKIP that is also used to drive the switching stage of the DC-DC converter, particularly to skip pulses of the PWM driving signal.

It is noted that the error amplifier 100 for frequency compensation may include a simple voltage-to-voltage amplification device (e.g., a conventional operational amplifier), which relies on a local feedback network arranged between the amplifier's output and inputs (not visible in FIG. 2) to make it stable. Alternatively, the error amplifier 100 may include a voltage-to-current amplification device (e.g., an Operational Transconductance Amplifier, OTA), which is an open-loop amplifier stage with no local feedback.

In clocked PWM-based converters, the duration of the switching cycle is fixed and dictated by a reference clock, which determines the beginning of the coil charging phase (Ton) and the overall duration of the switching cycle, i.e., the period of the ramp signal V_{S}. Such coil charging phase lasts until the PWM comparator 102 triggers (e.g., until the moment when signal COMP_PWM switches to an asserted state, logic ‘1’). This event determines the end of the coil charging phase in favor of the coil discharging phase (Toff), during which the coil is discharged, until the next clock falling edge (i.e., until the beginning of a new switching cycle). Cycle by cycle, the PWM comparator 102 triggers when the ramp signal V_{S} intercepts the control signal V_{C} produced by the error amplifier 100. Depending on the control algorithm, the ramp signal V_{S} may be a fixed sawtooth signal (e.g., in case of a voltage-mode control algorithm) or it may contain also signal information regarding the coil current (e.g., in case of a current-mode control algorithm). Generally speaking, the control signal V_{C} carries information about the required duty-cycle of the drive signal of the DC-DC converter.

When the DC-DC converter operates in DCM or skip-mode, the output signal COMP_SKIP of the skip comparator 104 is also monitored. This signal, when de-asserted (e.g., set to logic ‘0’), indicates the need to stop the switching activity (e.g., deliberately skipping one or more PWM cycles) and wait the next clock cycle, or—on the contrary, when asserted—it indicates the need to start again to energize the coil and provide charge to the output load. By setting the value of the skip threshold signal REF_SKIP it is possible to tune the conditions under which the converter enters the skip-mode. In other words, the value of the threshold signal REF_SKIP poses a limit on the minimum duty-cycle at which the converter can operate before switching to skip-mode operation.

As previously discussed, there is a need to provide a converter including a control circuit that detects whether the converter is skipping pulses (e.g., skipping PWM cycles) at a frequency falling within a prohibited frequency band, and in the affirmative case implements a corrective action.

As for the “detection” part of the control circuit, a clock signal CLOCK having a (fixed) frequency F_{CLOCK} higher than the maximum forbidden frequency is exploited as a time reference. For instance, the reference clock signal CLOCK may have a frequency in the order of 1 MHz or more; by way of example, the frequency of signal CLOCK may be the same frequency F_{SW} at which the converter operates in CCM. The skip control signal COMP_SKIP produced by the skip comparator 104 reflects the DC-DC converter skip behavior, therefore by monitoring signal COMP_SKIP and comparing its behavior over time with the reference clock signal CLOCK it is possible to infer information about the converter skip behavior. In particular, it is possible to understand if the converter is skipping at a frequency that is not allowed (e.g., that lies in one of the stop bands): this can be done by detecting (e.g., counting) the repetition rate of the skip comparator (e.g., the distance between two consecutive rising edges and/or two consecutive falling edges of signal COMP_SKIP) leveraging the available reference clock signal CLOCK.

One or more embodiments may rely on the recognition that, if the converter is skipping PWM cycles at a frequency that lays within a stop band, a certain (e.g., expected) number of periods of signal COMP_SKIP have to be detected within a given timeframe (e.g., 1 ms): a counter COUNTER1 may be used for this purpose, as further disclosed in the following. If this condition is met, i.e., if the number of periods of signal COMP_SKIP detected during a defined timeframe falls in a specified range, it means that within such a timeframe the converter is skipping at an average frequency that may be potentially avoided. However, no information about the actual/instantaneous skip frequency may be inferred from such a monitoring effected over a relatively long time period. Therefore, the reference clock signal CLOCK may also be exploited to check if the actual/present skip burst lays within a prohibited stop-band. If this is not the case (i.e., if the instantaneous skip frequency is sufficiently far from the stop-band), the aforementioned counter COUNTER1 is not increased but reset. Indeed, continuing to count instead of resetting the counter COUNTER1 would likely lead to the end of the timeframe with a number of detected periods of signal COMP_SKIP that confirms that the converter is skipping at a frequency not included in the stop-band. Alternatively, continuing to count the number of skip periods within the timeframe even if a single skip burst is not within the stop band may lead to a condition where, at the end of the timeframe, the number of detected periods of signal COMP_SKIP actually confirms that on average the converter is skipping at a frequency within the stop-band. Implementing a corrective action based only on the information about the average skipping frequency may be dangerous and/or incorrect, since in this case (i.e., when only the skip frequency averaged over the timeframe lays within the forbidden band and not the instantaneous skip frequency) the converter may just be experiencing a transient. In the case of transients, corrective actions should not be put in place, insofar as it may be safer waiting until the end of any such potential transient and only then checking if a corrective action actually has to be put in place. Additionally, resetting the counter COUNTER1 as soon as a current (e.g., actual/present) skip burst lays outside of the prohibited stop-band is useful in that the counter is immediately ready to start counting again and may thus be faster to detect a potential forbidden band.

Therefore, in one or more embodiments a control circuit for a DC-DC converter may implement an algorithm that detects (e.g., declares) that the converter is operating in skip-mode at a forbidden frequency when both of the following conditions are true:
first condition (CONDITION1): in a given timeframe TF (measured in seconds), the number of detected periods of signal COMP_SKIP (e.g., the number of rising edges or falling edges) falls in the range [TF*FMIN÷TF*FMAX], where FMIN is the lower limit of the forbidden frequency band and FMAX is the upper limit of the forbidden frequency band; this condition indicates that, on average, the converter is skipping at a prohibited frequency; and
second condition (CONDITION2): the number of periods (e.g., the number of pulses, counting the rising edges and/or the falling edges) of the reference clock signal CLOCK detected between two consecutive rising edges of signal COMP_SKIP falls in the range [floor(F_{CLOCK}/FMAX)−M÷ceil(F_{CLOCK}/FMIN)+M], where floor( ) is the floor function that takes only the integer part of its argument, ceil( ) is the ceiling function that rounds its argument to the next integer, F_{CLOCK} is the frequency of the reference clock signal CLOCK, and M is a margin parameter.

The first condition (CONDITION1) refers only to the averaged behavior of the converter in a (fixed) timeframe (e.g., TF=1 ms). As anticipated, the first condition alone may not be sufficient to allow a robust and correct detection as to whether the converter skip frequency is within the stop-band or not. The first condition in fact may not provide information about the density of periods of the skip control signal COMP_SKIP; in other words, it may not provide information about the instantaneous skip frequency of the converter. For such a reason, checking also the second condition (CONDITION2) improves the reliability of the detection as to whether the converter skip frequency is within the stop band or not. Differently from the first condition, the second condition provides information about the instantaneous skip frequency of a single actual/present burst. Also, this information may not be sufficient when considered on its own, because it may be too coarse, depending on how higher the frequency of the reference clock signal CLOCK is with respect to the higher limit of the forbidden frequency band (i.e., FMAX).

It is noted that in principle, one may be tempted to rely only on the detection of CONDITION1. This approach would prove correct only in the case of a converter operating always in steady state. However, DC-DC converters are complex non-linear systems including feedback paths and showing different transient responses to changes in operative conditions (e.g., load, line, etc.). Therefore, a detection based only on the first condition would be prone to errors and deceptive when considering real scenarios with transients, since it would not be possible to recognize if the converter is experiencing a transient or if the converter is operating in steady state. Adding the second condition allows to filter out temporary transient conditions of the converter and postpone the decision to the next timeframe analysis. During a transient, deploying a corrective action may be dangerous and/or wrong, insofar as such a corrective action may not actually be needed. For example, one may think of a case in which the converter just goes through the forbidden frequency band due to a load transient, and eventually settles outside of the forbidden band: here, a corrective action may exacerbate the transient, worsening the converter response.

In one or more embodiments, the control circuit of a DC-DC converter may thus include a first circuit portion (e.g., a first finite state machine) configured to monitor the first condition (CONDITION1) and a second circuit portion (e.g., a second finite state machine) configured to monitor the second condition (CONDITION2). The two state machines cooperate with counter circuits to monitor the two conditions.

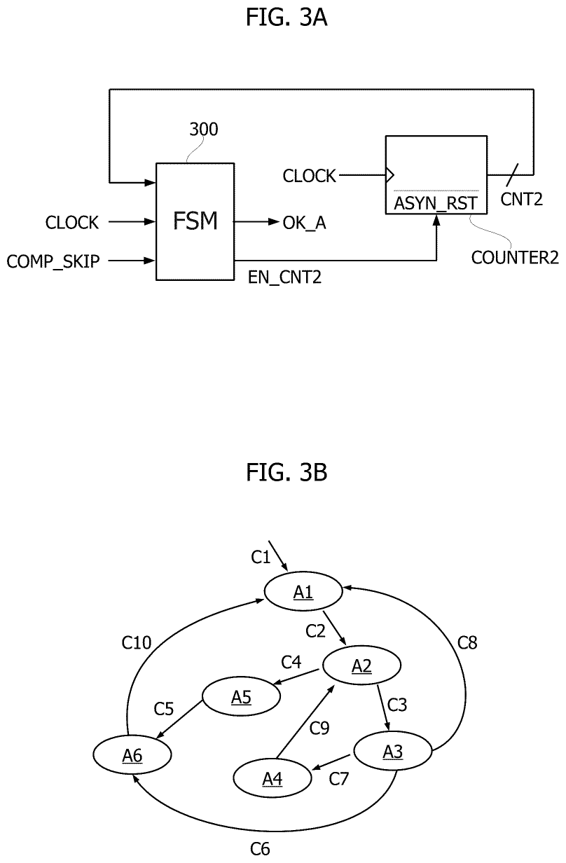

FIG. 3A is a circuit block diagram exemplary of the portion 300 of the control circuit and a corresponding counter circuit COUNTER2 that are configured to monitor the second condition, and FIG. 3B is a state diagram exemplary of the operating states of the finite state machine (FSM) implemented by circuit 300.

Circuit 300 receives as input the reference clock signal CLOCK at frequency F_{CLOCK}, the skip control signal COMP_SKIP of the converter device, and the signal CNT2 produced by the counter COUNTER2. Circuit 300 produces as output a first detection signal OK_A that is asserted and de-asserted when the second condition (CONDITION2) is true and false, respectively, as well as an enable signal EN_CNT2 that enables the counter COUNTER2. The counter COUNTER2 receives the reference clock signal CLOCK and the enable signal EN_CNT2 to produce the count signal CNT2. The enable signal EN_CNT2 operates as an active-low asynchronous reset for the counter: when EN_CNT2=0, the counter is reset to the initial value of 0; when EN_CNT2=1, the counter is not in reset anymore and its value CNT2 gets increased at each pulse of the clock signal CLOCK (e.g., at each rising edge or falling edge, or even at both the rising and falling edges in case of maximum exploitation of the reference clock signal CLOCK to increase the resolution).

The circuit of FIGS. 3A and 3B is thus configured to check if the actual/present burst may potentially lay within the forbidden frequency band. Such circuit does not have memory of previous pulses of signal COMP_SKIP, but only senses the current pulse at the present moment. Leveraging the reference clock signal CLOCK, the counter COUNTER2 is used to count how many clock periods are present between two consecutive pulses of signal COMP_SKIP (e.g., between two rising edges). However, even using a high frequency clock signal CLOCK, it may not be always possible to reach the resolution required to understand if the current burst is at a frequency within the forbidden band. This may be true especially for the higher frequency stop-bands, where the condition F_{CLOCK}>>FMAX may not be satisfied. For this reason, a margin M on this detection may be allowed, as previously discussed.

Substantially, as exemplified in FIG. 3B, the FSM 300 moves to an initial state A1 when a rising edge in signal COMP_SKIP is detected (trigger C1). In state A1, the outputs are OK_A=1 and EN_CNT2=0. From state A1, the FSM 300 moves to state A2 when a rising edge in signal CLOCK is detected (trigger C2). In state A2, the outputs are OK_A=1 and EN_CNT2=1, so the counter COUNTER2 starts counting, increasing by one unit at each period of the clock signal CLOCK. From state A2, the FSM 300 can move either to state A3 when a falling edge in signal COMP_SKIP is detected (trigger C3), or to state A5 when too many periods of signal CLOCK have been counted so that surely CONDITION2 is already false, i.e., if the value of signal CNT2 is higher than ceil(F_{CLOCK}/FMIN)+M (trigger C4), depending on which event happens first. In state A3, the outputs are OK_A=1 and EN_CNT2=1, so the counter COUNTER2 continues counting; in state A5, the outputs are OK_A=0 and EN_CNT2=0, so the counter COUNTER2 gets reset to zero. From state A5, the FSM 300 moves to state A6 when a falling edge in signal COMP_SKIP is detected (trigger C5). In state A6, the outputs are OK_A=0 and EN_CNT2=0, so the counter COUNTER2 gets reset to zero. From state A3, the FSM 300 can move either to state A6, state A4 or state A1 depending on which event happens first. If the first event that takes place is that too many periods of signal CLOCK have been counted so that surely CONDITION2 is already false (i.e., if the value of signal CNT2 is higher than ceil(F_{CLOCK}/FMIN)+M), the FSM 300 moves from state A3 to state A6 (trigger C6). If instead the first event that takes place is the detection of a rising edge in signal COMP_SKIP, the FSM 300 moves from state A3 to state A4 if CONDITION2 is false (trigger C7), or it moves from state A3 back to state A1 if CONDITION2 is true (trigger C8). In state A4, the outputs are OK_A=0 and EN_CNT2=0, so the counter COUNTER2 gets reset to zero. From state A4, the FSM 300 moves back to state A2 when a rising edge in signal CLOCK is detected (trigger C9). From state A6, the FSM 300 moves back to state A1 when a rising edge in signal COMP_SKIP is detected (trigger C10).

Therefore, substantially, the detection circuit exemplified in FIGS. 3A and 3B is configured to keep signal OK_A asserted as long as the number of pulses (e.g., periods) of the reference clock signal CLOCK detected during a period (e.g., between two consecutive rising edges) of signal COMP_SKIP falls in the range [floor(F_{CLOCK}/FMAX)−M÷ceil(F_{CLOCK}/FMIN)+M], possibly indicating operation of the converter in the prohibited frequency band, and de-assert signal OK_A as soon that condition is not satisfied. This is achieved insofar as the counter COUNTER2 gets reset at each rising edge of signal COMP_SKIP, or in any case when CONDITION2 is not satisfied even if the FSM is still waiting for the next rising edge of signal COMP_SKIP.

In one or more embodiments, the overflow of counter COUNTER2 may be selected to occur when the number of periods (or half-periods, in case of maximum exploitation of the reference clock signal to maximize the resolution) of the clock signal CLOCK has actually exceeded the maximum possible number to be inside the forbidden band (plus margin M). Waiting for the natural overflow of counter COUNTER2 would worsen the algorithm response time and in turn the whole system performance. It is also noted that when the DC-DC converter operates in CCM or in fixed frequency DCM, the counter COUNTER2 is expected to overflow continuously, insofar as signal COMP_SKIP is never asserted and thus does not include any edge.

In one or more embodiments, the control circuit of FIGS. 3A and 3B is able to automatically adapt to a real time (e.g., on-the-fly) change of the converter setpoint and/or selected stop-band. In this case, such a change may be managed updating the limit values of the range for the second condition (CONDITION2) on-the-fly, without the need of synchronizing this event with any particular state of the finite state machine 300, since the finite state machine 300 may react transparently without remaining stuck, independently from the present state, due to the fact that the FSM 300 does not retain memory of the previous/past pulses (i.e., the history) of signal COMP_SKIP, but it is only concerned with the present/actual skip pulse.

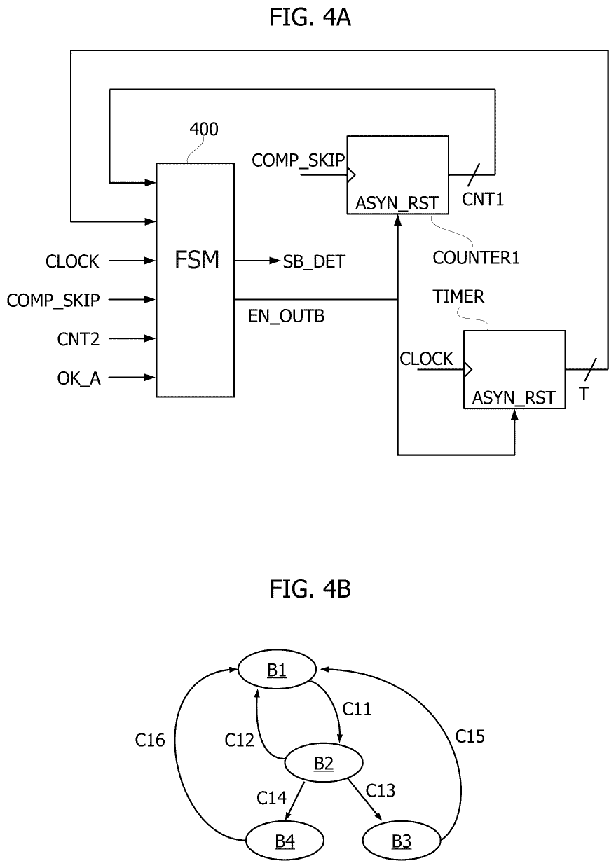

FIG. 4A is a circuit block diagram exemplary of the portion 400 of the control circuit and corresponding counter circuits TIMER and COUNTER1 that are configured to monitor the second condition, and FIG. 4B is a state diagram exemplary of the operating states of the finite state machine (FSM) implemented by circuit 400.

Circuit 400 receives as input the reference clock signal CLOCK at frequency F_{CLOCK}, the skip control signal COMP_SKIP of the converter device, the signal CNT2 produced by the counter COUNTER2, the signal OK_A produced by circuit 300, the signal CNT1 produced by the counter COUNTER1, and the signal T produced by the counter TIMER. Circuit 400 produces as output a first detection signal SB_DET that is asserted and de-asserted when the first condition (CONDITION1) is true and false, respectively, as well as an enable signal EN_OUTB that enables the counters COUNTER1 and TIMER. The counter COUNTER1 receives the skip control signal COMP_SKIP and the enable signal EN_OUTB to produce the count signal CNT1, and the counter TIMER receives the reference clock signal CLOCK and the enable signal EN_OUTB to produce the count signal T. The enable signal EN_OUTB operates as an active-low asynchronous reset for the counters COUNTER1 and TIMER: when EN_OUTB=0, the counters are reset to the initial value of 0; when EN_OUTB=1, the counters are not in reset anymore and their values CNT1 and T get increased at each rising edge of the skip control signal COMP_SKIP and at each pulse of the clock signal CLOCK (e.g., at each rising edge or falling edge, or even at both the rising and falling edges in case of maximum exploitation of the reference clock signal CLOCK to increase the resolution), respectively.

The circuit of FIGS. 4A and 4B is thus configured to count how many periods of signal COMP_SKIP occur within the given timeframe TF.

Substantially, as exemplified in FIG. 4B, the FSM 400 starts from an initial state B1. In state B1, the outputs are SB_DET=0 and EN_OUTB=0. From state B1, the FSM 400 moves to state B2 when a rising edge in signal CLOCK is detected (trigger C11). In state B2, the outputs are SB_DET=0 and EN_OUTB=1, so the counters COUNTER1 and TIMER start counting, increasing by one unit at each period of signal COMP_SKIP and signal CLOCK, respectively. From state B2, the FSM 400 can move to state B3, B4 or back to state B1 depending on which event happens first. If a falling edge of signal CLOCK is detected and COMP_SKIP=0 and CNT2=0, the FSM 400 moves from state B2 back to state B1 (trigger C12). This mechanism allows to start counting the timeframe only when the first pulse of signal COMP_SKIP occurs: since it is not known a priori when the first pulse of signal COMP_SKIP is going to happen, continuously starting and resetting COUNTER1 and TIMER until the first pulse of signal COMP_SKIP occurs allows to introduce a maximum timing error of a single CLOCK period on the timeframe. In other words, in the worst case, TIMER is started—and the timeframe is counted—a single CLOCK period in advance. Alternatively, the FSM 400 moves from state B2 to state B3 (trigger C13) if at timeout (i.e., when the end of the timeframe TF is reached, indicated by the value of counter signal T) the first condition (CONDITION1) is true, i.e., the value of signal CNT1 falls within the determined range. In state B3, the outputs are SB_DET=1 and EN_OUTB=“don't care”. Alternatively, the FSM 400 moves from state B2 to state B4 (trigger C14) if at timeout the first condition (CONDITION1) is false, or if the value of signal CNT1 exceeds the upper limit of its allowed range, or if a falling edge of signal OK_A is detected. In state B4, the outputs are SB_DET=0 and EN_OUTB=“don't care”. The FSM 400 moves from state B3 or state B4 back to state B1 (triggers C15 and C16, respectively) if COMP_SKIP=0 and CLOCK=0, preparing for a new timeframe cycle.

Therefore, substantially, the detection circuit exemplified in FIGS. 4A and 4B is configured to start counting when a first rising edge is detected in signal COMP_SKIP and keep counting until one of the following events happen: TIMER timeout (i.e., end of monitoring timeframe TF reached): in this case it is checked whether the number of counted periods (e.g., rising edges) of signal COMP_SKIP is within the forbidden band or not (CONDITION1 check); the circuit 300 de-asserts its output OK_A (e.g., OK_A=0), signaling that there is no need to keep counting the periods of signal COMP_SKIP, and that both counters COUNTER1 and TIMER can be reset to start again; or counter COUNTER1 overflows, indicating that a high number of pulses of signal COMP_SKIP have occurred and the skip frequency is thus much higher than the upper limit of the forbidden band (i.e., CNT1>TF*FMAX before the end of the sampling window/timeframe TF).

If the number of counted periods of signal COMP_SKIP is within the stop-band, an output flag is raised (e.g., signal SB_DET is asserted, SB_DET=1) to signal that a corrective action has to be put in place. On the contrary, if the number of counted periods of signal COMP_SKIP is not within the stop-band when the signal T of counter TIMER reaches the timeout value, nothing is signaled and the state machine 400 is ready for a new cycle.

In one or more embodiments, the overflow of counter COUNTER1 may be selected to occur when the number of periods of signal COMP_SKIP has actually exceeded the maximum possible to be inside the forbidden band (possibly, plus a margin). Waiting for the natural overflow of counter COUNTER1 would worsen the algorithm response time and in turn the whole system performance, delaying the detection of a potential forbidden band. It is also noted that when the skip frequency is well above the stop-band, the overflow of counter COUNTER1 is expected; conversely, when the skip frequency is below or close to the stop-band, timeout of TIMER is expected.

Turning now to the description of the “corrective” part of the control circuit of the DC-DC converter, it is again noted that, when the DC-DC converter is allowed to operate in DCM or skip-mode, the skip threshold signal REF_SKIP dictates the equivalent duty-cycle that determines a change of operation, from a fixed frequency PWM-based DCM, to a non-PWM variable frequency skip/burst-mode. In fact, as previously discussed, the skip threshold REF_SKIP poses a limit on the minimum duty-cycle at which the converter can operate prior to entering into skip-mode operation. The skip behavior of a certain DC-DC converter is different as a function of different values of the skip threshold signal REF_SKIP: in particular, the converter is going to operate with different output ripple, coil current, skip frequency and duty-cycle value that triggers the change from fixed-frequency PWM-based operation to variable-frequency non-PWM skip/burst operation.

One or more embodiments may thus implement a detection algorithm that recognizes whether the DC-DC converter is regulating the output voltage with a skip/burst frequency within a (e.g., pre-selected) forbidden frequency range and, in the affirmative case, varies (e.g., moves) the value of the reference voltage signal monitored by the skip comparator 104, i.e., varies the value of the skip threshold signal REF_SKIP. In particular, the value of signal REF_SKIP may be changed adding an offset REF_SKIP_OFFSET with respect to a default value. In one or more embodiments, such an offset REF_SKIP_OFFSET is initially positive and is iteratively increased until the converter exits from the forbidden frequency band. If a maximum positive offset value is reached, at a next iteration the offset value REF_SKIP_OFFSET is set to a negative value which is iteratively decreased until the converter exits from the forbidden frequency band. The iterative process may repeat in case the operation of the converter falls again within a forbidden frequency band.

Initially adding an (increasing) positive offset REF_SKIP_OFFSET and then jumping to an (increasing) negative offset REF_SKIP_OFFSET is motivated by the fact that, in order to push the converter outside of the forbidden frequency band, it may not be possible to know easily and a priori whether it is better to increase or decrease the value of the skip threshold signal REF_SKIP. Therefore, if increasing the skip threshold signal REF_SKIP does not prove to be effective within a limited number of iterations (because a corrective action keeps to be requested), decreasing the skip threshold signal REF_SKIP is likely going to be effective.

In one or more embodiments, the step size of the offset value REF_SKIP_OFFSET may be designed so that in the worst-case (e.g., at a certain operating point and for a selected stop-band), the variation of the skip threshold signal REF_SKIP is sufficient to exit from any pre-defined forbidden frequency band with a finite number of iterations. For instance, referring to a non-limiting example, a maximum of seven iterations may be needed to find the correct value of the offset REF_SKIP_OFFSET. The algorithm setting speed may be tuned considering a trade-off between the object of limiting the perturbation to the system and minimally affecting the skip performances, while also limiting the design complexity.

Additionally, in one or more embodiments, depending on the complexity of the converter, the offset step size can be tailored according to the converter regulation setpoint, or more generally according to specific ranges (e.g., different offset step sizes may be used for different setpoints).

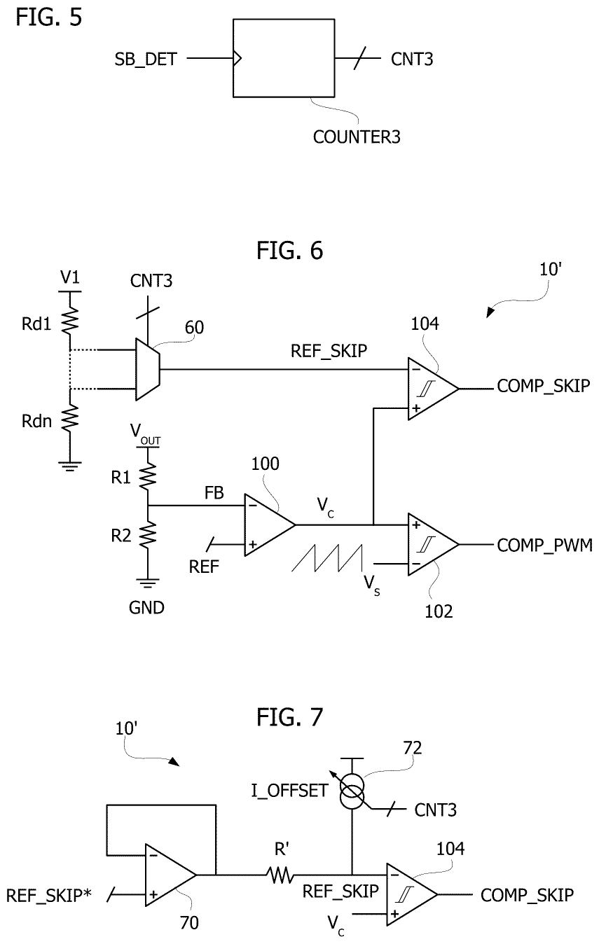

In one or more embodiments, the iterative corrective procedure described above may be implemented with a dedicated counter circuit COUNTER3 as exemplified in FIG. 5. The output signal CNT3 from counter COUNTER3 is used to update the value of the skip threshold signal REF_SKIP provided to the skip comparator 104. The counter COUNTER3 gets increased when the circuit 400 exemplified in FIG. 4A acknowledges and indicates that the converter is operating within a prohibited frequency band. As discussed with reference to the state diagram exemplified in FIG. 4B, this happens when the finite state machine implemented by circuit 400 reaches the state B3, and asserts its output signal SB_DET.

Therefore, the counter COUNTER3 receives signal SB_DET at its clock input terminal, and outputs its count value as a signal CNT3, thereby keeping track of the corrective actions (e.g., maintaining the history/memory) and updating the corrective actions.

In one or more embodiments, the counter COUNTER3 is designed to start counting from 0 and is allowed to rollover (not reset). Indeed, such a counter keeps the history of the corrective actions deployed, therefore it should rollover without being reset: this facilitates to exit from future steady state conditions in which the converter may again operate within a forbidden frequency band, insofar as the skip behavior of a DC-DC converter (e.g., frequency, output voltage ripple, coil current, etc.) is dependent on the input voltage V_{IN} and on the output current I_{LOAD}.

Table I is exemplary of the value of the offset REF_SKIP_OFFSET which is added, as a corrective measure, to the skip threshold signal REF_SKIP at each iteration of a corrective procedure as disclosed herein, and the corresponding value of signal REF_SKIP and of signal CNT3.

TABLE I

| | REF_SKIP | | REF_SKIP_OFFSET |
|---|---|---|---|
| Iteration no. | [V] | CNT3 <2:0> | [mV] |
| 0 (default) | 0.4 | 0 | 0 |
| 1 | 0.425 | 1 | +25 |
| 2 | 0.45 | 2 | +50 |
| 3 | 0.48 | 3 | +80 |
| 4 | 0.55 | 4 | +150 |
| 5 | 0.375 | 5 | −25 |
| 6 | 0.35 | 6 | −50 |
| 7 | 0.30 | 7 | −100 |

| | |
|---|---|
| 8 | Back to iteration no. 1 |

In one or more embodiments, an analog circuit may thus receive the digital signal CNT3 from counter COUNTER3 and may generate different signals REF_SKIP for comparator 104 as a function of the value of signal CNT3, as exemplified in Table I. This function can be obtained according to a variety of different circuit architectures, which substantially operate as digital-to-analog (DAC) interfaces. By way of example, two possible implementations are disclosed in the following, with reference to FIGS. 6 and 7.

FIG. 6 is a circuit diagram exemplary of components of a control loop 10′ of a DC-DC converter including a pulse-skip function, according to one or more embodiments of the present description. Parts/elements similar to those of FIG. 2 are indicated with the same reference number without repeating the corresponding description. As exemplified in FIG. 6, a voltage divider network (e.g., a resistive divider or resistive ladder including n resistors Rd1 to Rdn) is supplied by a constant voltage V1 (e.g., equal to 1.2 V) and produces different voltages at each resistor tap. An (e.g., analog) multiplexer circuit 60 receives the digital signal CNT3 and the intermediate voltages from the voltage divider Rd1, . . . , Rdn, and passes a selected one of the intermediate voltages to its output as signal REF_SKIP as a function of the value of signal CNT3. In other words, multiplexer 60 links a specific digital code provided by signal CNT3 to an equivalent analog voltage signal. Multiplexer 60 may include simple switches (e.g., pass-gates), and each switch connects the reference (e.g., negative) input terminal of comparator 104 to a different tap of the resistive ladder Rd1, . . . , Rdn that produces a voltage signal higher or lower than the default skip threshold signal. Therefore, a variation of the digital code CNT3 produces a variation of the skip threshold signal REF_SKIP monitored by the skip comparator 104.

One or more embodiments as exemplified in FIG. 6 may be advantageous insofar as they are simple and do not consume a significant extra current. For instance, the reference voltage divider Rd1, . . . , Rdn may be already present in the converter circuit for other purposes. Additionally, such embodiments may provide a high degree of freedom in the sizing the offset steps and may facilitate the implementation of non-uniform and/or non-linear steps for potentially each different output setpoint.

FIG. 7 is a circuit diagram exemplary of components of a control loop 10′ of a DC-DC converter including a pulse-skip function, according to other embodiments of the present description. Again, parts/elements similar to those of FIG. 2 are indicated with the same reference number without repeating the corresponding description. As exemplified in FIG. 7, a voltage buffer circuit 70 receives a fixed skip threshold voltage signal REF_SKIP* and propagates it to a first terminal of a resistor R′. For instance, the voltage buffer circuit 70 may include an operational amplifier that receives signal REF_SKIP* at its non-inverting input terminal and has its inverting input terminal directly connected to its output terminal. Resistor R′ may have a second terminal coupled to the reference (e.g., inverting) input terminal of skip comparator 104. A variable (e.g., programmable) current source 72 is coupled to a terminal of resistor R′ to source a current I_OFFSET thereto, the value of current I_OFFSET being dependent on the value of signal CNT3. Therefore, starting from a fixed skip threshold voltage signal REF_SKIP* it is possible to add a variable voltage offset to produce a variable skip threshold voltage signal REF_SKIP by sourcing a programmable current I_OFFSET to resistor R′.

Voltage buffer circuit 70 allows decoupling the voltage signal REF_SKIP* from the following stages and exploiting it as a high impedance signal. Variations of digital signal CNT3 correspond to variations of the skip threshold signal REF_SKIP monitored by the skip comparator 104, since values of signal CNT3 correspond to different values of current I_OFFSET and thus to different offsets introduced.

In one or more embodiments, the programmable current generator 72 may include a programmable P-channel current mirror. In this case, since the programmable current I_OFFSET can be only positive (i.e., only a positive offset can be added to signal REF_SKIP*), signal REF_SKIP* is different from the default value (e.g., 0.4 V in the example of Table I) and it equals the lowest value (e.g., CNT3=7, REF_SKIP*=0.3 V in the example of Table I). In other embodiments, the programmable current generator 72 may be more complex, allowing to source both positive and negative current I_OFFSET. In this case, since both positive and negative offset voltages can be added to signal REF_SKIP*, signal REF_SKIP* can be selected to be equal to the default value (e.g., CNT3=0, REF_SKIP*=0.4 V in the example of Table I).

Compared to the embodiments of FIG. 6, the embodiments of FIG. 7 may be more complex and may add a small extra current consumption. Additionally, the embodiments of FIG. 7 may allow less freedom in the custom sizing of different offset steps (e.g., it may be more difficult to implement non-uniform and/or non-linear steps dedicated for different setpoints).

According to further embodiments (not illustrated in the Figures), the same result may be obtained with a fixed offset current I_OFFSET, while changing the value of resistor R′. In this case, the variable offset is obtained programming the resistor value (e.g., connecting more resistors in parallel or in series) according to the value (code) of signal CNT3.

When the DC-DC converter is experiencing a transient (e.g., load, line, etc.), the skip frequency may change—even over a wide range, depending on the perturbation's magnitude—and finally settle at a certain value. Detecting such transient allows to wait for the end of the transient without deploying an unnecessary and potentially dangerous corrective action. According to the solution described herein, even a single burst that is outside the forbidden band is enough for the finite state machine 400 to promptly reset the sampling window (i.e., the timer TIMER) and the burst counter (i.e., counter COUNTER1). In this way, during a transient, the finite state machine 400 keeps shifting ahead (e.g., delaying the start of) the sampling window, since there is no need of a corrective action in this moment and the converter may just wait, delaying the check at the end of the transient. In the meanwhile, the finite state machine 300 remains in idle and both counters TIMER and COUNTER1 are continuously reset, without updating the corrective action. When the DC-DC converter reaches a new steady state, its frequency settles. Counters TIMER and COUNTER1 remain enabled (e.g., they do not get reset anymore) only when/if the burst frequency is coarsely within, or close to, the forbidden frequency band. At this point, it is checked whether the skip frequency averaged in the timeframe is within the stop-band or not. In other words, a solution as disclosed herein acts as a filter that rejects the converter transients, and the need to update the corrective action is evaluated only at the end of a steady-state sampled window (e.g., a timeframe in which the converter is in steady state).

When a new output regulation setpoint is selected on the fly (e.g., in real-time with the DC-DC converter operating to regulate the output), the overall system is reset. The finite state machines 300 and 400 lose their history and start again from their initial state, without memory of the previous actions nor DC-DC behavior. The same applies when a new forbidden frequency range is selected on the fly.

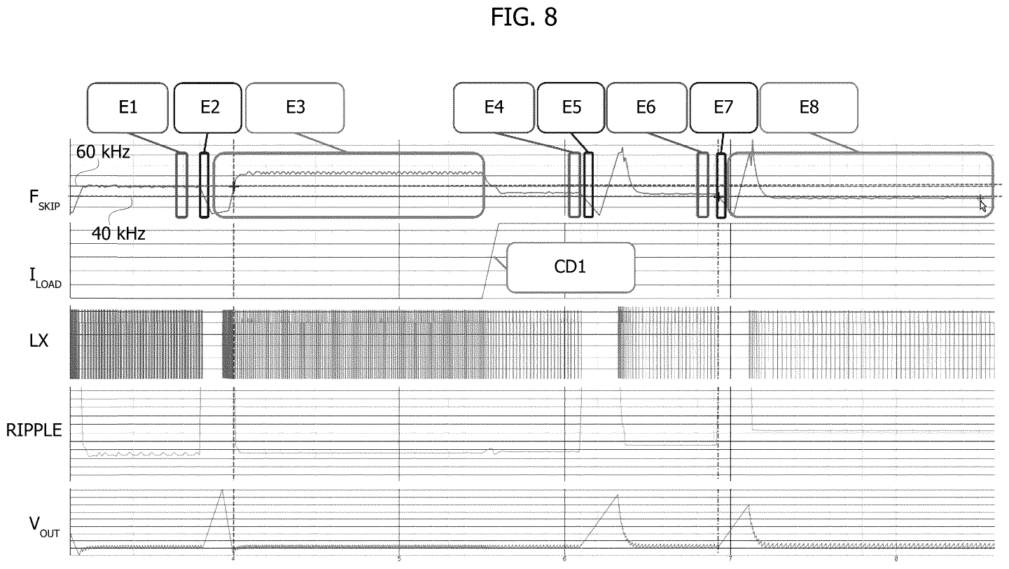

Operation of one or more embodiments may be further understood with reference to FIG. 8, which is a time diagram exemplary of possible time evolution of signals in a DC-DC converter according to the present description. In particular, FIG. 8 shows the converter skip frequency F_{SKIP} (topmost waveform), output current I_{LOAD} (second waveform from top), the voltage LX at the switching node of the converter (third waveform from top), the output ripple RIPPLE (fourth waveform from top), and the output voltage V_{OUT} (last waveform from top). In the example of FIG. 8, the DC-DC converter is an inverting buck-boost converter regulating a negative voltage V_{OUT} of −9 V and PWM-controlled with a switching frequency F_{SW} of 1.5 MHz. The forbidden frequency range is fixed from 40 kHz to 60 kHz and the sampling timeframe is set to 0.5 ms. In this example, the converter is operating in low power mode with a load current of −10 mA and specifically in burst-mode, with burst/skip frequency F_{SKIP}.

As exemplified in FIG. 8, initially, after a short transient, the converter reaches a steady state condition with a burst frequency of almost 60 kHz, which is within the forbidden range. At the end of a fixed timeframe of 0.5 ms, the control loop detects that the converter is operating with a burst frequency within the stop-band (event E1) and therefore a corrective action is produced (event E2—e.g., an offset is added to the skip threshold signal REF_SKIP monitored by comparator 104). Such action perturbates the converter, which then settles with a burst frequency above the forbidden frequency range (event E3—e.g., about 85 kHz). At about 5.5 ms, the load current is lowered to −5 mA (condition CD1) and the converter reaches a new steady state after experiencing a transient. In this new condition, the skip frequency falls again inside the forbidden range (e.g., at a value just above 40 kHz). The control loop detects such event (event E4) after about 0.5 ms and provides a corrective action (event E5) remembering the previous one (e.g., the offset on the skip threshold signal REF_SKIP is increased). The converter reacts on this action and reaches a new steady state that is different from the previous (e.g., has a different output ripple), but the new burst frequency is still within the stop-band. The control loop detects such a condition (event E6) and executes another iteration (event E7—e.g., it increases again the offset on the skip threshold signal SKIP REF monitored by comparator 104). With this additional action, the converter settles with a final steady state frequency of about 37.5 kHz, lower than the forbidden band (event E8).

It is also noted that embodiments as disclosed herein may be configured to continuously check the frequency of signal COMP_SKIP and may respond with a corrective action after a time equal to the selected timeframe TF plus the amount of time needed by the converter to settle in steady state (i.e., outside a transient), which depends on the type and amount of the perturbation.

One or more embodiments as disclosed herein may thus provide one or more of the advantages discussed in the following.

In the present description, a method to monitor the skip frequency of a DC-DC converter is disclosed, which allows to determine the converter state and react accordingly. The monitoring method allows to filter out the converter transients and wait for the end of transients before checking if a corrective action has to be put in place, thereby improving the converter overall performance.

A specific control variable, that is the skip threshold signal REF_SKIP, allows to move the burst/skip operation of the converter outside a forbidden frequency band. Such a control variable is orthogonal for CCM operation, since it is monitored (by skip comparator 104) only in skip mode. In this way, CCM operation and performance—such as control loop stability, efficiency, current capability—are not affected. In other words, the control variable does not affect operation in CCM mode, since in CCM the control algorithm disclosed herein remains in idle.

By resorting to an iterative approach, the adaptive correction algorithm implemented by one or more embodiments reduces the perturbation introduced in the original/default operative point. Such an iterative approach based on small steps (step-by-step trial and adjust) allows to introduce a perturbation having a small magnitude, e.g., the minimal magnitude that is effective in driving the converter operation outside of a forbidden frequency band. Therefore, in one or more embodiments the overall DC-DC behavior is only slightly affected in skip-mode, particularly in terms of output ripple and efficiency at light load conditions.

In one or more embodiments, a DC-DC converter is able to avoid operation in given frequency bands while providing the expected regulation performance in all operative conditions, independently from possible PVT variations. Additionally, the iterative approach disclosed herein is robust and allows to exit from future/next steady state conditions in which the DC-DC converter may again operate within a forbidden frequency band (as discussed with reference to the example of FIG. 8).

Embodiments as disclosed herein do not pose constraints on the DC-DC converter itself, allowing high flexibility and versatility in terms of design of the control loop. Various embodiments may be applied to DC-DC converters implemented within power management integrated circuits (PMICs) for AMOLED power supplies and controlled in current mode (e.g., peak-current mode), but other embodiments may be applied to any other DC-DC converter, not limited to current-controlled converters (e.g., voltage mode, etc.). Additionally, the embodiments disclosed herein perform well no matter the converter—in non-PWM mode—operates strictly in skip-mode or burst-mode.

The burst-mode case is discussed referring back to the example of FIG. 8. In this case, since the DC-DC converter specifically operates in burst mode, changing the skip threshold signal SKIP REF monitored by comparator 104 means that the converter operates—in steady state—not only with a different burst frequency, but also with a different number of packets (e.g., switching pulses) within a single period of COMP_SKIP. The relation between the skip threshold signal REF_SKIP and burst operation frequency is not monotonous in burst-mode operated DC-DC converters. FIG. 8 is exemplary of such behavior: the first increase of signal REF_SKIP (first corrective action) increases the burst frequency, while the next increase of signal REF_SKIP reduces such frequency. The robustness of the proposed solution allows to support such non-monotonous behavior, since the corrective action is agnostic and it automatically adapts iteratively until the perturbation introduced on the skip threshold signal REF_SKIP is sufficient to push the converter outside of the stop-band. It may be irrelevant whether the DC-DC is pushed above or below the stop-band.

On the contrary, the relation between the skip threshold signal REF_SKIP and skip operation frequency may be monotonous in skip-mode operated DC-DC converters, where the converter operates in single pulse and not in burst. Again, the proposed solution is effective also in this context, insofar as its operation does not make a distinction between the different non-PWM modes.

One or more embodiments may be applied in any application that is subject to strict requirements to avoid operating in specific frequency bands (e.g., for EMI/EMC reduction in specific bands, for practical compliance with other nearby devices and/or systems in high density SoCs/SiPs/SoMs). One or more embodiments are applicable to any DC-DC converter topology, since the proposed control loop is independent from the topology of the switching bridge (e.g., buck/boost/buck-boost/inverting buck-boost, etc.) and deployed on a higher level (i.e., system level) without involving the particular configuration of the converter switches.

One or more embodiments allow a high-level of tuning according to the imposed forbidden frequency bands, with no limitations and high flexibility. The algorithm core can be embedded (e.g., synthetized) within the digital controller of the DC-DC converter as HDL (hardware-description-language) code written and verified following the common standard practices.

Both the exemplary implementations that carry out the corrective action (see FIGS. 6 and 7) rely on a mixed approach of digital assisted analog design.

One or more embodiments facilitate enhancing the overall converter performance without degrading any other specification. The proposed solution is robust by design and not sensitive to mismatch, PVT variations, operating conditions nor other causes happening after final-test, packaging and assembly (e.g., aging, soldering, etc.). This is mostly due to the iterative, flexible and agnostic correction approach, combined with the hybrid/mixed nature of the proposed solution. No complex/critical IP cores nor high frequency signals are required.

Without prejudice to the underlying principles, the details and embodiments may vary, even significantly, with respect to what has been described by way of example only, without departing from the extent of protection.

The claims are an integral part of the technical teaching provided herein in respect of the embodiments.

The extent of protection is determined by the annexed claims.

1. A DC-DC converter circuit, comprising:
a switching stage configured to implement a switching operation to produce an output voltage;
an error amplifier having a first input terminal configured to receive a feedback signal indicative of said output voltage, a second input terminal configured to receive a reference voltage signal, and an output configured to produce a duty-cycle control signal for the DC-DC converter;
a first comparator having a first input terminal configured to receive said duty-cycle control signal, a second input terminal configured to receive a ramp signal, and an output configured to produce a pulse-width modulated drive signal for controlling said switching stage;
a second comparator having a first input terminal configured to receive said duty-cycle control signal, a second input terminal configured to receive a skip threshold signal, and an output configured to produce a skip control signal for controlling said switching stage, wherein the switching operation of said switching stage is halted in response to said skip control signal being de-asserted;
a clock generator configured to produce a clock signal; and
a control circuit configured to:
count a number of periods of said skip control signal during a monitoring time window having a defined duration;
count a number of periods of said clock signal during a period of said skip control signal;
assert a common detection signal when said counted number of periods of said skip control signal is within a first range and said counted number of periods of said clock signal is within a second range; and
vary a value of said skip threshold signal in response to said common detection signal being asserted.

2. The DC-DC converter circuit of claim 1, wherein said control circuit comprises a first circuit portion comprising:
a first counter configured to receive said clock signal at a respective clock input terminal and a first enable signal at a respective asynchronous reset terminal, wherein the first counter is reset in response to said first enable signal being de-asserted, and counts pulses of said clock signal in response to said first enable signal being asserted to produce a first count value;
a first logic circuit configured to receive said clock signal, said skip control signal and said first count value and produce said first enable signal and a first detection signal;
wherein:
said first enable signal is asserted when an edge of said clock signal is detected and is de-asserted when said first count value is higher than an upper limit of said second range, and is further periodically de-asserted at the start of each period of said skip control signal; and
said first detection signal is asserted when an edge of said skip control signal is detected, and is de-asserted when said first count value is higher than said upper limit of said second range or when, at the start of a period of said skip control signal, said first count value is outside of said second range.

3. The DC-DC converter circuit of claim 2, wherein said control circuit comprises a second circuit portion comprising:
a second counter configured to receive said clock signal at a respective clock input terminal and a second enable signal at a respective asynchronous reset terminal, wherein the second counter is reset in response to said second enable signal being de-asserted, and counts the pulses of said clock signal in response to said second enable signal being asserted to produce a timer count value;
a third counter configured to receive said skip control signal at a respective clock input terminal and said second enable signal at a respective asynchronous reset terminal, wherein the third counter is reset in response to said second enable signal being de-asserted, and counts the pulses of said skip control signal in response to said second enable signal being asserted to produce a second count value;
a second logic circuit configured to receive said clock signal, said skip control signal, said first count value, said first detection signal, said second count value and said timer count value and produce said second enable signal and said common detection signal;
wherein:
said second enable signal is asserted in response to a pulse in said clock signal and is de-asserted in response to at least one of:
i) said clock signal being de-asserted and said second count value being equal to 0 and said skip control signal being de-asserted;
ii) said timer count value reaching a threshold value;
iii) said second count value being higher than said first range, and
iv) said first detection signal being de-asserted, and
said common detection signal is asserted when said second count value is within said first range when said timer count value reaches a threshold value.

4. The DC-DC converter circuit of claim 3, further comprising a fourth counter configured to produce a third count value indicative of a number of consecutive assertions of said common detection signal, wherein said control circuit is configured to vary the value of said skip threshold signal as a function of said third count value.

5. The DC-DC converter circuit of claim 4, wherein said control circuit is configured to iteratively adjust the value of said skip threshold signal in response to said third count value increasing.

6. The DC-DC converter circuit of claim 4, wherein said control circuit is configured to iteratively increase the value of said skip threshold signal while said third count value is lower than a threshold value and iteratively decrease the value of said skip threshold signal while said third count value is higher than a threshold value.

7. The DC-DC converter circuit of claim 5, further comprising:
a resistive voltage divider configured to produce a plurality of voltage signals; and
a multiplexer circuit configured to select, as a function of said third count value, one voltage signal of said plurality of voltage signals for application to said second input terminal of said second comparator.

8. The DC-DC converter circuit of claim 5, further comprising:
a reference input node configured to receive a further reference voltage signal;
a voltage buffer circuit configured to propagate said further reference voltage signal to a first terminal of a resistor, said resistor having a second terminal coupled to said second input terminal of said second comparator; and
a programmable current source configured to source a programmable current to said second terminal of said resistor, wherein the value of said programmable current is dependent on said third count value.

9. The DC-DC converter circuit of claim 5, further comprising:
a reference input node configured to receive a further reference voltage signal;
a voltage buffer circuit configured to propagate said further reference voltage signal to a first terminal of a programmable resistor, said programmable resistor having a second terminal coupled to said second input terminal of said second comparator, wherein the resistance value of said programmable resistor is dependent on said third count value; and
a current source configured to source a current to said second terminal of said programmable resistor.

10. A method of operating a DC-DC converter circuit, comprising:
performing a switching operation of a switching stage to produce an output voltage at an output;
determining a difference between a feedback signal indicative of said output voltage and a reference voltage signal to produce a duty-cycle control signal for the DC-DC converter;
first comparing said duty-cycle control signal and a ramp signal to produce a pulse-width modulated drive signal for controlling said switching stage;
second comparing said duty-cycle control signal and a skip threshold signal to produce a skip control signal for controlling said switching stage, wherein the switching operation of said switching stage is halted in response to said skip control signal being de-asserted;
producing a clock signal;
counting a number of periods of said skip control signal during a monitoring time window having a defined duration;
counting a number of periods of said clock signal during a period of said skip control signal;
asserting a common detection signal when said counted number of periods of said skip control signal is within a first range and said counted number of periods of said clock signal is within a second range; and
varying a value of said skip threshold signal in response to said common detection signal being asserted.

11. A DC-DC converter circuit, comprising:
a switching stage configured to implement a switching operation to produce an output voltage;
an error amplifier having a first input terminal configured to receive a feedback signal indicative of said output voltage, a second input terminal configured to receive a reference voltage signal, and an output configured to produce a duty-cycle control signal for the DC-DC converter;
a first comparator having a first input terminal configured to receive said duty-cycle control signal, a second input terminal configured to receive a ramp signal, and an output configured to produce a pulse-width modulated drive signal for controlling said switching stage;
a second comparator having a first input terminal configured to receive said duty-cycle control signal, a second input terminal configured to receive a skip threshold signal, and an output configured to produce a skip control signal for controlling said switching stage, wherein the switching operation of said switching stage is halted in response to said skip control signal being de-asserted; and
a control circuit configured to detect from changes in state of the skip control signal whether the DC-DC converter circuit is skipping pulses in the pulse-width modulated drive signal at a frequency falling within a prohibited frequency band, and in response thereto vary a value of said skip threshold signal.

12. The DC-DC converter circuit of claim 11, wherein the control circuit is configured to:
determine over a plurality of periods of the skip control signal whether the frequency at which the DC-DC converter circuit is skipping pulses in the pulse-width modulated drive signal falls within the prohibited frequency band to assert a first signal indicating an average skip frequency that falls within the prohibited frequency band;
determine over a single period of the skip control signal whether the frequency at which the DC-DC converter circuit is skipping pulses in the pulse-width modulated drive signal falls within the prohibited frequency band to assert a second signal indicating an instantaneous skip frequency that falls within the prohibited frequency band;
wherein the value of said skip threshold signal is varied only if both the first and second signals are asserted.

13. The DC-DC converter circuit of claim 12, wherein determining over a plurality of periods comprises determining that each period of the skip control signal falls within a range given by the equation TF*FMIN÷TF*FMAX, where TF is a time duration, FMIN is a lower limit of the prohibited frequency band and FMAX is an upper limit of the prohibited frequency band.

14. The DC-DC converter circuit of claim 12, wherein determining over a single period comprises determining that a number of periods of a reference clock signal within one period of the skip control signal falls within a range given by the equation floor(FCLOCK/FMAX)−M÷ceil(FCLOCK/FMIN)+M, where floor( ) is a floor function, ceil( ) is a ceiling function, FCLOCK is a frequency of the reference clock signal, and M is a margin parameter.

15. A method of operating a DC-DC converter circuit, comprising:
performing a switching operation of a switching stage to produce an output voltage at an output;
determining a difference between a feedback signal indicative of said output voltage and a reference voltage signal to produce a duty-cycle control signal for the DC-DC converter;
first comparing said duty-cycle control signal and a ramp signal to produce a pulse-width modulated drive signal for controlling said switching stage;
second comparing said duty-cycle control signal and a skip threshold signal to produce a skip control signal for controlling said switching stage, wherein the switching operation of said switching stage is halted in response to said skip control signal being de-asserted;
detecting from changes in state of the skip control signal whether the DC-DC converter circuit is skipping pulses in the pulse-width modulated drive signal at a frequency falling within a prohibited frequency band; and
in response thereto, varying a value of said skip threshold signal.

16. The method of claim 15, wherein detecting comprises:
determining over a plurality of periods of the skip control signal whether the frequency at which the DC-DC converter circuit is skipping pulses in the pulse-width modulated drive signal falls within the prohibited frequency band to assert a first signal indicating an average skip frequency that falls within the prohibited frequency band; and
determining over a single period of the skip control signal whether the frequency at which the DC-DC converter circuit is skipping pulses in the pulse-width modulated drive signal falls within the prohibited frequency band to assert a second signal indicating an instantaneous skip frequency that falls within the prohibited frequency band;
wherein varying comprises varying the value of said skip threshold signal only if both the first and second signals are asserted.

17. The method of claim 16, wherein determining over a plurality of periods comprises determining that each period of the skip control signal falls within a range given by the equation TF*FMIN÷TF*FMAX, where TF is a time duration, FMIN is a lower limit of the prohibited frequency band and FMAX is an upper limit of the prohibited frequency band.

18. The method of claim 16, wherein determining over a single period comprises determining that a number of periods of a reference clock signal within one period of the skip control signal falls within a range given by the equation floor(FCLOCK/FMAX)−M÷ceil(FCLOCK/FMIN)+M, where floor( ) is a floor function, ceil( ) is a ceiling function, FCLOCK is a frequency of the reference clock signal, and M is a margin parameter.
